(19) United States
(12) Patent Application Publication
(10) Pub. No.: US 2022/0055472 A1
(43) Pub. Date: Feb. 24, 2022

(54) ELECTRIC MOTOR AND CLUTCH

(71) Applicant: TEXA DYNAMICS S.R.L., Monastier di Treviso (IT)

(72) Inventor: Bruno VIANELLO, Monastier di Treviso (IT)

(21) Appl. No.: 17/433,620

(22) PCT Filed: Feb. 21, 2020
(86) PCT No.: PCT/IB2020/051460

§ 371 Date: Aug. 25, 2021

(30) Foreign Application Priority Data
Feb. 25, 2019 (IT) 10201900002643

(51) Int. Cl. B60K 6/40; B60K 6/38; H02K 16/02; H02K 7/00; H02K 7/108

(52) U.S. Cl. CPC B60K 6/40; B60K 6/38; H02K 16/02; B60Y 2410/10; H02K 7/108; B60Y 2200/92; B60Y 2400/424; H02K 7/006

(57) ABSTRACT

An electric motor-clutch assembly is described, wherein the electric motor comprises a rotor comprising a free surface which forms part of the external surface of the motor,
the clutch comprises a friction disc and
the friction disc is mounted axially movable to selectively contact said free surface.

The present invention relates to an electric motor and related clutch, and to a construction method for an electric motor and related clutch. The instant invention also refers to an electric vehicle (assisted electrically) having two or more wheels, such as a Segway, an automobile or a tractor or an electric bicycle.

Hybrid vehicles equipped with an electric motor and a combustion engine are known, wherein the two motors can be selectively connected to each other or to a mechanical transmission to transfer driving torque to the wheels via two disc clutches. Disc clutches, although now technologically developed, contribute significantly to the longitudinal dimensions of the motor-clutch assembly, in contrast with the trend towards miniaturization. Other disadvantages are the higher costs due to the greater number of components.

For reasons of weight, bulk and number of pieces, it would be very advantageous to be able to reduce the size of the electric motor-clutch assembly.

The main object of the invention is to improve this state of the art.

Another object of the invention is to create a method for building an electric motor—clutch assembly with smaller longitudinal dimensions and/or lower cost.

Another object of the invention is to create an electric motor-clutch assembly with smaller longitudinal dimensions and/or lower cost.

These and other objects are achieved by what is defined in the appended independent claims; other advantageous technical features are defined in the dependent claims.

An aspect of the invention is an electric motor-clutch assembly, wherein

the electric motor comprises a rotor comprising a free surface which forms part of the external surface of the motor,

the clutch comprises a clutch disc, and

the clutch disc is mounted axially movable for selectively contacting said free surface.

A general advantage of the invention is that, referring to the exemplary drawing, the external side of the rotor 20a and 20b of the motor can be exploited. And it is possible, without inserting an additional disc, to implement on side 24 the clutch function combining it with the disc unit and the disc-pushing unit 40a and 40b.

In a variant, the rotor is a disc, for ease of construction and adaptation to the clutch disc.

In a variant, the rotor comprises a side on which permanent magnets are mounted and an opposite side which constitutes said free surface.

In a variant, the electric motor comprises

a first and second rotor as defined above, and respectively

a first and second friction disc as defined above,

the two rotors being positioned axially on opposite sides of the motor, in such a way that the free surfaces of the two rotors face opposite directions. In particular, the two rotors are integral with each other or selectively connectable to each other to become integral to each other by means of controllable-connection means.

Another aspect of the invention is a vehicle comprising an electric motor-clutch assembly as defined above.

In a variant, the clutch is connected to an internal combustion engine.

In a variant, the clutch is connected to a mechanical transmission shaft adapted to transfer driving torque to a wheel.

In a variant, the motor comprises said two rotors, and the first clutch is connected to an internal combustion engine and the second clutch is connected to a mechanical transmission shaft adapted to transfer driving torque to a wheel.

An aspect of the invention is a method of constructing an electric motor-clutch assembly, with the step of

mounting a clutch disc axially movable so that it can selectively contact a portion of the external surface of the motor, wherein said portion belongs to a rotor of the motor.

Further advantages will become clear from the following description, which refers to a preferred example of embodiment in which:

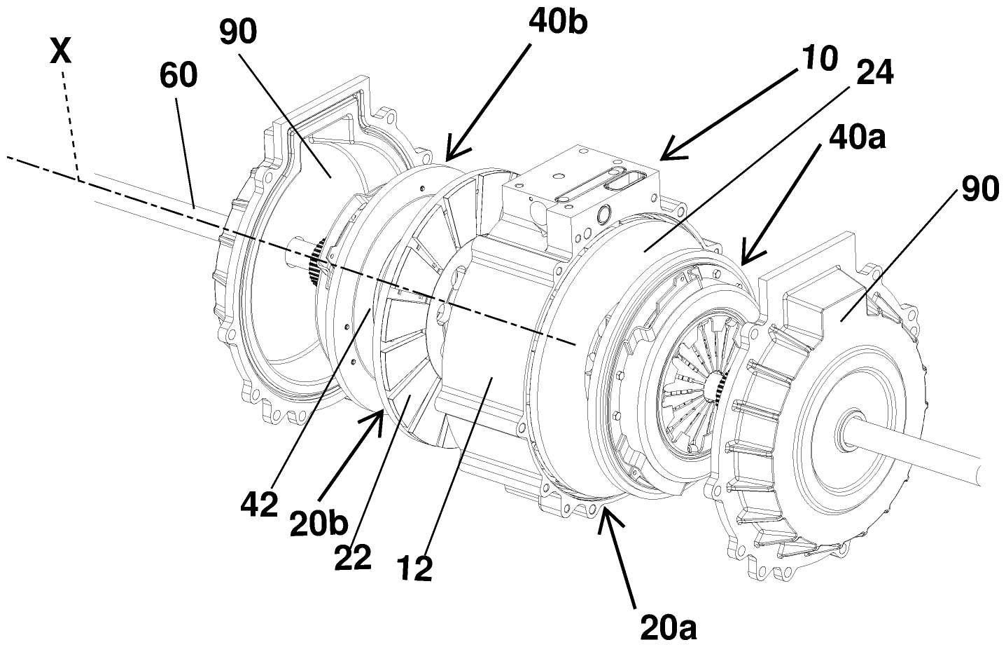

FIG. 1 shows a three-dimensional view of an electric motor-clutch assembly.

An electric motor-clutch assembly is formed by an electric motor 10 and two clutches 40a,b.

The motor 10 has a stator housing or stator 12 in which a first rotor 20a and a second rotor 20b, integral with each other, are mounted rotatably.

In the example, the rotors 20a, 20b are in the form of two discs and are e.g. equal. The rotors 20a, 20b are provided with a respective free surface 24 which forms part of the external surface of the housing 12, are rotatable about the same X axis and are located on opposite sides of the housing 12, in such a way that the free surfaces 24 of the two rotors 20a, 20b face opposite directions.

Each clutch 40a,b comprises a clutch disc 42 which is mounted axially movable, with known means, along the X axis to selectively contact the free surface 24 respectively of the rotor 20a, 20b facing it.

Each clutch 40a,b also comprises a protective cover 90 fixable to the housing 12.

According to a preferred variant, each rotor 20a, 20b comprises, on the side opposite to the surface 24, (e.g. permanent) magnets 22 adapted to magnetically interact with components of the stator 12.

The clutches 40a, b can be controlled independently of one another.

The electric motor-clutch assembly 10 can be advantageously integrated into a vehicle. In particular, in the vehicle the clutch 40a is connected to a combustion engine (not shown) and the clutch 40b is connected to a mechanical transmission shaft 60 capable of transferring driving torque e.g. to a wheel or to a shift gearbox (gears of the shift).

When the clutch 40a connects the disc 20a to the combustion engine, the latter can rotate the electric motor 10, otherwise the combustion engine remains isolated from the shaft 60 and from the motor 10.

In this configuration, if the clutch 40b is not engaging, the combustion engine can e.g. rotate the rotors 20a, 20b to generate electrical energy to recharge a battery onboard the vehicle (not shown). Or the motor 10 can be controlled to operate as an active flywheel for the combustion engine, with the advantage e.g. to filter torque variations.

When the clutch 40b connects the disc 20b to the shaft 60, the motor 10 can drive the shaft 60 into rotation, otherwise the motor 10 remains isolated from the shaft 60. In this configuration, the motor 10 can transfer torque to the shaft 40.

When each clutch 40a, b is connected to the respective disc 20a, b the motor 10 and the combustion engine can both transfer torque to the shaft 60.

The motor 10 may also comprise a single rotor and relative clutch.

1. Electric motor-clutch assembly, wherein
the electric motor comprises a rotor comprising a free surface which forms part of the external surface of the motor,
the clutch; comprises a friction disc, and
the friction disc is mounted axially movable to selectively contact said free surface.

2. Assembly according to claim 1, wherein the rotor is a disc.

3. Assembly according to claim 2, wherein the rotor comprises a side on which there are mounted permanent magnets and an opposite side which constitutes said free surface.

4. Assembly according to claim 1, comprising
a first and second rotors as defined in any one of the preceding claims, and respectively
a first and second clutch disc as defined in any one of the preceding claims,
the two rotors being positioned axially on opposite sides of the motor, so that the free surfaces of the two rotors face opposite directions.

5. Vehicle comprising an electric motor-clutch assembly as defined in claim 1.

6. Vehicle according to claim 5, wherein the clutch is connected to a combustion engine or to a mechanical transmission shaft adapted to transfer torque to a wheel.

7. Vehicle according to claim 5, wherein the electric motor comprises said two rotors, and the first clutch is connected to an internal combustion engine and the second clutch is connected to a mechanical transmission shaft adapted to transfer torque to a wheel.

8. Method for constructing an electric motor-clutch assembly, with the step of
mounting a clutch disc axially movable so that it can selectively contact a portion of the external surface of the motor, wherein said portion belongs to a rotor of the motor.
